(19) United States
(12) Patent Application Publication
(10) Pub. No.: US 2007/0239760 A1
(43) Pub. Date: Oct. 11, 2007

(54) SYSTEM FOR PROVIDING AN INTERACTIVE INTELLIGENT INTERNET BASED KNOWLEDGEBASE

(76) Inventor: Daniel Simon, Santa Clara, CA (US)

Correspondence Address: Daniel Simon, 366 Sloat Ct, Santa Clara, CA, 95051, US

(21) Appl. No.: 11/279,108

(22) Filed: Apr. 9, 2006

(51) Int. Cl. G06F 7/00

(52) U.S. Cl. 707/102

(57) ABSTRACT

An Internet based computer application that consists of a back-end user interface for use by the client (“client”), and a front-end interface website for use by the end-user of the client (“user”, “end-user”), comprising customisable frequently asked questions (FAQs), help pages, discussion forums, downloadable documents, user created web pages, multiple word and phrase searching, query bot natural language parser, news and event ticker, and a customisable calendar. The front end is accessed by the end-user via a unique website address, and allows them access to the aforementioned features. The back end is accessed by the client using a unique username and password, and allows the client to modify all aforementioned features, an image library, account information, and other website features. All user-accessible features provide information to the user and provide feedback to the client, allowing them to adapt their website to the specific needs of their end-users.

### FIELD OF THE INVENTION

The present invention relates to an internet-based knowledgebase service website, mainly comprised of a knowledgebase (FAQs, help pages, discussion forums) that is created and maintained by a client (business or institution or individual) and accessible by a user (end-user of the business or patron of the institution or end-user targeted by the individual) using a series of intelligent sorting and search algorithms (query bot, case-insensitive word and phrase search), which in-turn relays usage information through a series of reports back to the client, who is then able to modify the knowledgebase and their website content accordingly.

### BACKGROUND OF THE INVENTION

Business professionals such as store owners, physicians, lawyers, dentists, mechanics, and service providers have many tools and services at their disposal when creating a static website or e-commerce website. In addition educators and other individuals have at their disposal a series of options when creating a website for their students or other target audience. However, these individuals and establishments do not have any readily available means of creating and maintaining any intelligent knowledgebase service online presence themselves if given limited funds and resources. They will typically create a series of FAQs that they determine to be useful and potentially a contact form, to allow end-users to find answers to questions and assist end-users online. This invention allows the individual, establishment, or institution to create and maintain an extensive knowledgebase consisting of FAQs, help pages, and discussion forums (in addition to several supplementary features) using a back-end interface. The back-end information populated by the client is automatically made available to their end-users via a front-end interface created by the aforementioned invention (for the individual, establishment, or institution). The end-users are given several tools to query the knowledgebase in an intelligent manner using natural English, case-insensitive word and phrase searches, and an interactive contact method to directly contact the individual, establishment, or institution should further assistance be needed. Furthermore, the front-end interface serves to transparently provide a detailed level of feedback to the client, available through a series of reports in the backend, that indicates to the client how to best maintain their knowledgebase and website to most effectively serve their end-users.

Automated natural language understanding systems are known. U.S. Pat. No. 5,895,466 to Goldberg, et al. discloses a method implemented by a computer-based querying system that allows an end-user service agent to query a knowledgebase using keyword extraction. The system in Goldberg, however, does not disclose a method for analyzing keywords based on phonetics, but rather based on exact keyword matches and syntactic and semantic similarity alone.

A method and apparatus for information retrieval from a database by replacing domain specific stemmed phases in a natural language to create a search query is known. U.S. Pat. No. 5,265,065 to Turtle discloses a method implemented by a computer-based querying system that builds a query string by removing stop words from the query, and then reducing all remaining words to their basic roots and comparing the resulting query to existing queries in a database. The system in Turtle does not disclose a method for analyzing keywords based on phonetics, but rather based on stop word removal and root words and synonym matching.

FAQ matching systems are also known. U.S. Pat. No. 6,028,601 to Machiraju, et al. discloses a method implemented by a computer-based FAQ system, which matches end-user questions to answers based on a coupling system where similar questions are searched. The system in Machiraju does not disclose a method for using a keyword matching system to phonetically match questions regardless of pre-existing similar questions in the database, and furthermore limits answers to those found in FAQs alone. The aforementioned system also does not disclose a method of dynamically generating a unique key for each FAQ created, which would in turn aid in the matching and searching process.

Another FAQ matching system is also known. U.S. Pat. No. 5,842,221 to Schmonsees discloses a method implemented by a computer-based FAQ interface which stores FAQ question and answer pairs, sorted by pre-defined topics in a database. Schmonsees fails to disclose a method for retrieving and sorting FAQs using a natural language parsing system to directly query FAQ questions, and also fails to disclose a method to automatically email an FAQ question and answer to a third party, a method to ask further questions about a FAQ, or a method to open a print friendly version of a given FAQ.

### SUMMARY OF INVENTION

The present invention relates to an Internet based knowledge system with many discrete features, each of which contributes to maintaining a larger client knowledgebase, made accessible to the client's end-users. The application runs on a remote computer, the remote computer being electronically coupled to the user interface via the Internet. The client accesses the application via the Internet by accessing a predefined URL (Uniform Resource Locator). The client creates an account on the remote computer and is able to log into a back-end system which allows them to create and maintain content that is automatically posted to a front-end website. The front-end website is hosted on the same remote computer and made accessible to the client's users and all other Internet users. All information and content maintained by the client through the back-end and made available to the user on the front-end is stored in a database middle layer, which is electronically coupled to computer software on the front-end and back-end. An application web page server is used to control requests to the server. The application server interacts with a back-end interpreter or compiler that receives requests from the application server to interpret or compile files using information supplied by the client's/user's Internet browser, and any required database interactions are made (dependent on the file being accessed). The compiler/interpreter returns a compiled file, formatted in HTML (Hyper Text Markup Language) which is returned and interpreted by the client's/user's Internet browser. This process is illustrated in FIG. 15. Other features and advantages will become apparent based on the following detailed description of the preferred embodiments and the claims.

### BRIEF DESCRIPTION OF THE DRAWINGS

FIG. 1 is a diagram of the back-end and front-end knowledgebase interaction;

FIG. 2 is a diagram of the DFS (Deterministic Finite State machine) that's used to parse queries into keywords;

FIG. 3 is a diagram of the DCTM (Data Collection and Transmission Module);

FIG. 4 is an illustration of how the FAQs are sorted on the front-end user facing website;

FIG. 5 is an illustration of how the processes that occur when a FAQ is emailed to a third party recipient;

FIG. 6 is an illustration of how the help pages are displayed; FIG. 7 is an illustration of how valid dictionary words are pulled from a sentence that cannot be parsed by the DFS;

FIG. 8 is an illustration of the key word parser; FIG. 9 is an example of how the key word extractor records transitions between consonants and vowels to get a syllable count;

FIG. 10 illustrates the relationship between client defined categories and the client defined dictionary;

FIG. 11 illustrates how the client's URL is generated when their account is created;

FIG. 12 illustrates the interaction between the client/user Internet browser, the application server, interpreter, and database;

FIG. 13 illustrates how the client's initial request loads the client's front-end end-user-facing website;

FIG. 14 illustrates the interactions that take place during statistics compilation, where the database is queried and information is presented to the client;

### DESCRIPTION OF THE PREFERRED EMBODIMENTS

The subheadings used herein are meant only so as to aid the reader and are not meant to be limiting or controlling upon the invention. Generally, the contents of each subheading are readily utilized in the other subheadings.

The Web Server

The software application is accessed via the Internet, a network of electronic signals which in part couples a remote user's computer to a remote server, hosting (running) the software application described here-in. Electronic requests are sent from the user's computer (FIG. 15,2) using an Internet browser computer application (FIG. 15,1) to the web server (FIG. 15,7) via the Internet. The web server is electronically coupled to a computer language (such as PHP, C++, C#, Java, PERL) interpreter/compiler (FIG. 15,3). Upon receiving the browser request, the web server requests the electronically stored file (FIG. 15,9) that was requested by the remote browser client application, which is then retrieved from electronically coupled internal computer memory (RAM), and is then processed by the interpreter/compiler. The interpreter/compiler may conditionally interact (FIG. 15,4) with an electronically coupled database (FIG. 15,5). Once the requested file has been processed, it is returned to the web server (FIG. 15,6), which then returns the processed requested file to the client browser via the Internet (FIG. 15,8), which interprets the returned file and displays it to the user.

Overview

Business owners, professionals (such as doctors, physicians, lawyers, accountants, and veterinarians), and service providers often have very limited resources at their disposal, and cannot afford to devote the required resources to provide a rich online knowledgebase system to their customer base. In addition educators and other individuals do not have at their disposal an intelligent knowledgebase system capable of assisting end-users automatically via the internet. An affordable and often used alternative is a static website with a list of FAQs and a contact form. The present invention, allows the individual, establishment, or institution to easily create and maintain a dynamic, and rich knowledgebase system capable of adapting to future end-user needs using an interactive knowledgebase comprised of FAQs, help pages, and discussion forums.

The back-end system allows the client to optionally create and maintain content, such as custom web pages, news ticker events, downloadable documents, and custom calendar events, in addition to the aforementioned knowledgebase items. The client is also able to customize several front-end features, including the color/style of the front-end website, the query bot name and appearance, the front-end website home page, and the modules (as listed above) accessible to the end-user on the front-end website. The client, at their discretion, can create additional account administrative user accounts in the system, capable of accessing the back-end maintenance modules. Each additional account user created is given a set of permissions, which defines which modules they have access to and is editable by the client.

The front-end system gives the end-user and all other Internet users access to the client's front-end website, and is accessed using a unique Internet URL generated by the system for each client upon account creation.

The client's URL is generated by parsing the client's establishment name (FIG. 14,1), replacing all non-alpha-numeric characters with underscores (“ ”) (FIG. 14,2), and appending that value to the predefined URL. Once the URL has been generated, the database is searched (FIG. 14,4) for matching (existing) URLs. In the event that a predefined URL already exists, an incremental number is appended to the client's establishment name (FIG. 14,3) and the check is performed again. When the client's account is created, an index file is created (FIG. 14,5) and the URL is recorded (FIG. 14,7) in the database (FIG. 14,6). The client's index file contains machine readable code that instructs the client's Internet browser to redirect the end-user to the primary predefined URL, and creates a unique session containing information about the client's account settings in the form of variables stored in electronic memory. When the client index file (FIG. 16,2) is requested by the browser (FIG. 16,1) the browser is redirected (FIG. 16,3) to the system index page, the clients information is read (FIG. 16,4) from the database (FIG. 16,6), and the predefined system index page (FIG. 16,6) is loaded with the client's information. The session variables are stored on the same remote server as the application. When the end-user attempts to access the client's website, the application server on the remote server is instructed to load the index file, which in turn redirects the end-user's Internet browser and sets the session variables, as described above. This results in a successful loading of the client's front-end end-user-facing website. This process is illustrated in FIG. 14 and FIG. 16.

The end-user can potentially have access to the FAQs, help pages, discussion forums, custom web pages, document download center, a custom calendar, query bot search assistant, case-insensitive word and phrase search, and news and event ticker, dependent on the configuration set up by the client.

Client Categories and Topics

FAQs, help pages, and dictionary words (described below) are all sorted by client defined categories and topics stored in the database. The client can create a limited or unlimited number of categories and topics determined by their account type. Categories and topics are meant to broadly represent or describe subfields and parts of the client's industry type.

A client can create categories and topics using a create/edit category graphical user interface (GUI) web page. To add a new category or topic field, the client clicks the “Add” HTML button. The page reloads with a new HTML text box at the bottom of the page, in which the client types in the new category. To edit an existing category, the client must click the corresponding “Edit” HTML button next to the category/topic text they wish to edit. An editable HTML text box (previously hidden in a HTML DIV layer hidden using JavaScript embedded on the page) with the current category text appears underneath the category text. The client is able to make any changes to the category in the text box. All changes (new categories and edits to existing categories) are saved to the database when the client clicks the “Submit” HTML button.

The Client Dictionary

The client dictionary is typically a list of phrases and words common the client's industry, but is not restricted. The client can create a limited or unlimited number of dictionary words determined by their account type. The client dictionary may automatically be generated when FAQs and help pages are created, determined by their account type.

The client may optionally manually create and edit their dictionary using a back-end dictionary maintenance GUI web page, depending on their account type. The maintenance page consists of one HTML text area for each category that the client has created in the category editor GUI web page. The client types dictionary words in each category field and may elect to distribute them any way amongst the category sections. If no categories have been created, no dictionary words can be created manually and the client is prompted to create a set of categories before creating a dictionary. A dictionary word or phrase may only be used once in each field, and all dictionary words must be separated by commas (“,”). The client saves their current dictionary by clicking the “Submit” HTML button, which submits the page to the server. Once the page has been submitted, a JavaScript check breaks apart all dictionary words and checks for duplicates. If any duplicates are found, the page submission is aborted, and the client is informed and told which dictionary word is a duplicate and category section in which it appears. Furthermore, if too many dictionary words exist (depending on the client's account type), the client is prompted and asked to remove any excess dictionary words. Dictionary words may also optionally be created automatically by the application when a client creates a new FAQ or help page. If a new FAQ or help page contains no defined dictionary words, valid words are extracted using a process defined below in the FAQs section, and dictionary words are automatically inserted into the database.

Upon successful submission, all dictionary words are separated by commas (“,”) where they are individually inserted into the database, and sorted according to the categories in which they were created. The list of categories (FIG. 13,1) is broken up into individual categories (FIG. 13,2) (FIG. 13,3) (FIG. 13,4), and for each category a set of dictionary words is created (FIG. 13,5) (FIG. 13,6) (FIG. 13,7). Editing and creating dictionary words both follow the same procedure. FIG. 13 illustrates the interaction between client-defined dictionary words and categories.

The Knowledgebase

he knowledgebase is comprised of FAQs, help pages and discussion forums, each of which is deployable by the client. The client populates the knowledgebase in the back-end, at which time it becomes available to the end-user on the front-end, as illustrated in FIG. 1.

The end-user is able to interact with the knowledgebase in several ways: Query Bot: The end-user phrases a question to the query bot in natural language (English or another accepted language). The query bot then parses the question using a deterministic finite state automaton (DFS) as illustrated in FIG. 2. The DFS produces a key using the predefined dictionary words supplied by the client and searches the database for matching keywords. If a result is returned, the end-user is provided with HTML hyperlinks to the specific information. If no result is returned, the end-user's query is stored in the database and made accessible to the client in form of a query bot report.

Case-insensitive Word and Phrase Search: The end-user can search the knowledgebase using a basic case-insensitive word and phrase search. The end-user will enter the word or phrase in a HTML text box, select the module(s) to search (depending on their account type) by checking HTML checkboxes corresponding to the modules they wish to search, and submit their search by clicking a HTML button. If any matches are found, the relevant information is returned to the end-user with a highlighted snippet of text from the corresponding data source (FAQ, help page, or discussion forum).

FAQs and Help Pages: When an end-user clicks a FAQ title or help page link in order to view it, a record is made of the click and this record is later reported as part of the usage statistics. To handle the data collection, a special data collection module known as the DCTM (Data Collection and Transmission Module) is deployed to gather and sort the information into the database for retrieval at a later date, as illustrated in FIG. 3.

Each method and module is explained in greater detail below.

The DCTM

The DCTM (Data Collection and Transmission Module) acts as a listening layer that sits between the end-user-facing front-end website and back-end accessible by the client. As the end-user interacts with front-end modules (FIG. 3,2) and browses through data, the module records information about end-user clicks and activity and stores it in a database (FIG. 3,3). This information is accessible to the client through a back-end (FIG. 3,1) statistics report.

FAQs

The FAQ system allows the client to create and maintain frequently asked questions and answers on their end-user-facing front-end website using a back-end GUI web page. The GUI consists of a FAQ listing that lists the FAQs sorted by their respective categories presented in a HTML table. The client may delete any number of FAQs by checking the HTML checkbox corresponding to each FAQ title and clicking the “Delete” HTML button. Each FAQ title is a HTML hyperlink which opens the second state of the GUI, the FAQ create/edit page. The create/edit GUI web page is also accessible using the “Create New FAQ” HTML button, which opens a blank GUI form that allows the client to create a new FAQ.

The FAQ create/edit GUI web page allows the client to specify the FAQ question (a HTML text box), answer (a HTML text area), and a category to filter it into (presented as a HTML pull-down select box). The FAQ answer can optionally be edited/created using a HTML WYSIWYG editor. The editor allows the client to create rich text and format the text. Formatting options include (but are not limited to) bolding, italicizing, underlining, justifying (left, center, right, absolute), font, size, text color, background color, image insertion (from the client-defined image library), superscripting, subscripting, strikethrough, copy, paste, cut, undo, redo, search, insert number list, insert bulleted list, indent, and un-indent.

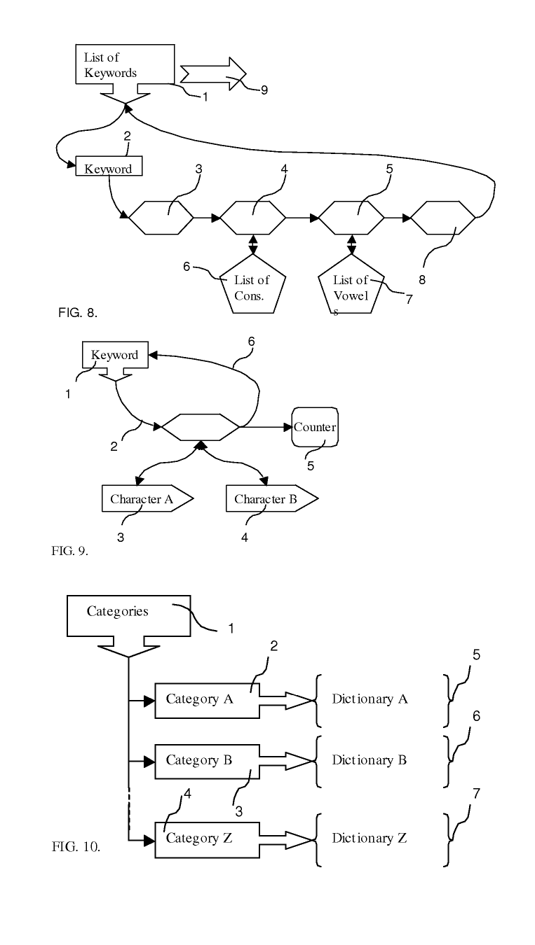

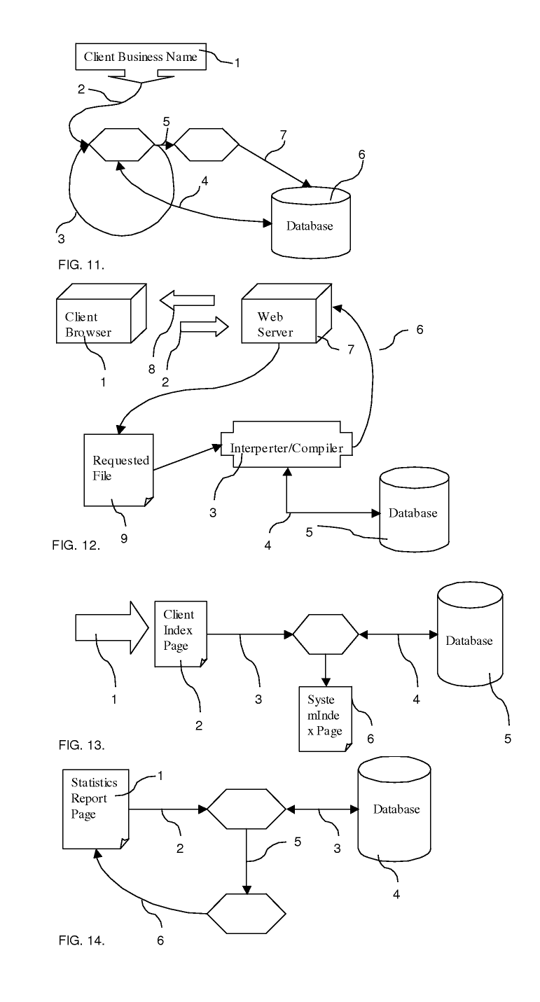

Once a client submits the create/edit FAQ GUI web page, the information for the FAQ is submitted to the server, saved in the database and a key is generated for the FAQ using the DFS and the client-defined set of dictionary words. The key is then stored with the FAQ in the database and used by the query bot. If no key is generated, the client may optionally be alerted (depending on the client's account type) via a JavaScript alert after the page submission that there were no valid dictionary words found in the current question, and thus no key was generated by the DFS. The client can then choose to be taken directly to the dictionary word create/edit GUI web page where several valid dictionary words are suggested (based on the content of the question of their last FAQ) that they can place in their dictionary. Valid dictionary words are suggested by removing all question words, punctuation, and common English words (all of which are stored in internal dictionary files in the system on the host server) from the FAQ. All remaining words are then suggested as valid dictionary words and the client can choose to use any of them in their dictionary. This process is illustrated in FIG. 8. Once the query string (FIG. 8,1) is received, it is first sent (FIG. 8,2) through a cleaning process that removes all question strings (FIG. 8,3), which are stored in a local hard coded question string dictionary (FIG. 8,4). The remaining portion of the string is then sent (FIG. 8,5) through a dictionary word cleaning process (FIG. 8,6), which removes all dictionary words found in the client defined dictionary (FIG. 8,7) stored in the database (FIG. 8,12). The string is sent (FIG. 8,8) through a punctuation word (character) cleaning process (FIG. 8,9), which removes all punctuation and common English words matching the punctuation characters and common words stored in the local hard coded punctuation and common word libraries (FIG. 8,10). The remainder of the string is then tokenized by spacing (breaks, spaces, tabs) and returned as a list of dictionary words (FIG. 8,11).

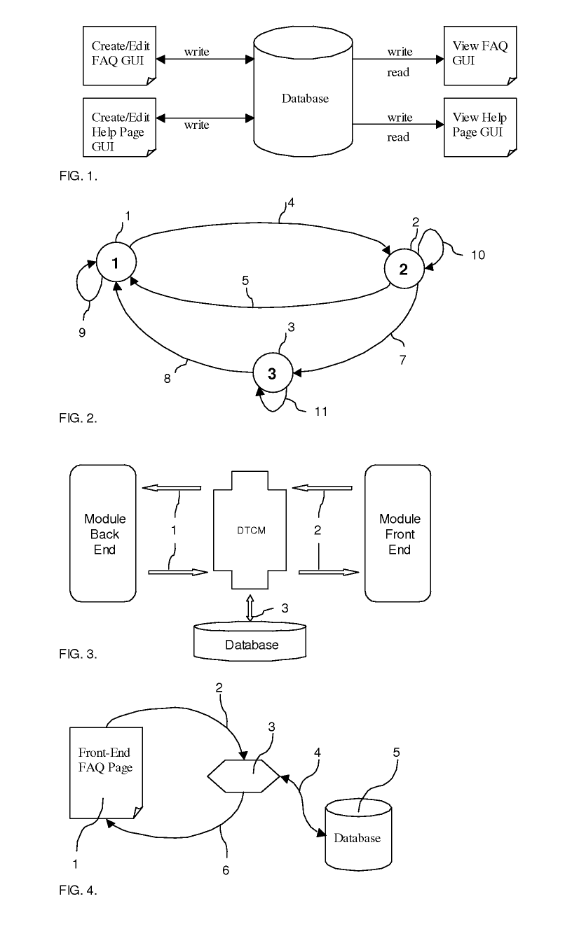

Once a client has created FAQs, they are made accessible via the front-end web site (FIG. 4,1) to the end-user and all Internet users. The FAQs can be sorted by the categories and topics (presented as a HTML pull-down select menu on the page) defined by the client in the back-end. The end-user selects a category or topic from the HTML select menu, at which point a JavaScript function on the end-user facing FAQ page submits the request to the server along with the desired sort category (FIG. 4,2). All FAQs coupled to the requested category are then retrieved (FIG. 4,4) from the database (FIG. 4,5), and the server (FIG. 4,3) returns the page (FIG. 4,6) with the filtered FAQs listed under the sort category/topic listed.

Each end-user-facing FAQ has three additional functionalities associated with it:

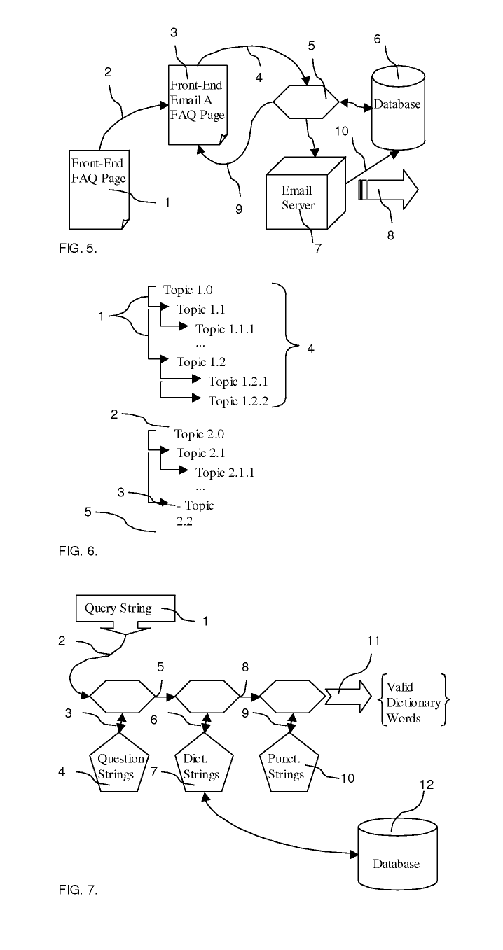

Email: Each FAQ (FIG. 5,1) can be emailed in its entirety to a third party. By clicking the corresponding email image button, an end-user opens a new Internet browser window (FIG. 5,2), containing an email GUI web page (FIG. 5,3). The GUI requires that the end-user supply a valid third party email address of the recipient and their (end-user's) email address and name (all in HTML text boxes). Upon submission, all data is validated using a JavaScript function. If any data is missing or formatted incorrectly a JavaScript error message is reported to the end-user indicating how to correct their error and then the page submission is aborted. If the information provided is valid, the page submits (FIG. 5,4) to the server (FIG. 5,5). The FAQ question and answer are pulled from the database (FIG. 5,6) and an email containing that information is composed and sent to the third party identified by the end-user in the email GUI web page (FIG. 5,8). The email is sent using an email server (FIG. 5,7) specified in the code interpreter/compiler configuration. In addition, the email address of the end-user and first and last name, also supplied in the GUI, are recorded in the database (FIG. 5,10) for identification purposes in the statistics page, as illustrated in FIG. 5. Once the email is sent and the information processed, the page closes using a JavaScript function (FIG. 5,9).

Printer Friendly Display: Every FAQ is available in a printer-friendly format. When an end-user clicks the printer-friendly icon button, a new Internet browser window opens, containing a printer-friendly formatted page. The page consists of the question in bold font, followed by the answer underneath, and “Print” and “Close” HTML buttons at the bottom of the page. If the “Print” button is clicked, a JavaScript function on the page performs a print command, which instructs the browser to attempt to print the current printer-friendly page. If “Close” is clicked, the window is closed.

Was this FAQ helpful: Every FAQ is appended with a question asking the end-user to indicate whether or not that specific FAQ was helpful, and a “Yes” and “No” HTML hyperlink. If the end-user clicks either “Yes” or “No”, the page is submitted and their answer recorded in the database for later use in the statistics compilation.

Help Pages

The help page system allows the client to create and maintain help pages on their front-end website using a back-end GUI. The GUI is comprised of a help page listing page that lists the help pages displayed in their hierarchical order. It also allows the client to delete any help page by clicking the HTML “delete” hyperlink at the end of each help page title. Each help page title is a HTML hyperlink, which when clicked opens the second part of the GUI—the help page creation/edit page. This create/edit page is also accessible using the “Create New Help Page” HTML button, which opens a blank GUI, allowing the client to create a new help page.

The create/edit help page GUI web page allows the client to specify the help page title (in a HTML text box), body (in a HTML text area), a parent topic (from a HTML select menu), a list of related topics (from a HTML select menu), and a category to filter it into (from a HTML select menu). The parent topics list and related topics list are presented as HTML select boxes, and consist of existing help topics already created by the client and stored in the database. Furthermore, the help page body can optionally be edited/created using a HTML WYSIWYG editor. The editor allows the client to create rich text, and format the text of the editor. Formatting options include (but are not limited to) bolding, italicizing, underlining, justifying (left, center, right, absolute), font, size, text color, background color, image insertion (from the client defined image library), superscripting, subscripting, strikethrough, copy, paste, cut, undo, redo, search, insert number list, insert bulleted list, indent, and un-indent.

Once a client submits the create/edit help page GUI web page, the information for the help page is saved in the database and a key is generated for the help page using the DFS. The key is then stored with the help page information in the database, and is used as a search element by the query bot. If no key is generated, the client may optionally be alerted (depending on the client's account type) after the page has been submitted via JavaScript that there were no valid dictionary words found in the current title, and thus no key was generated by the DFS. The client can then choose to be taken directly to the dictionary word form where they are given several suggestions (based on the content of their last help page) of valid dictionary words to place in their dictionary. Valid dictionary words are suggested by removing all question words, punctuation, and common English words (all of which are hard coded into an internal dictionary in the system) from the help page title, and all remaining words are then suggested as valid dictionary words and the client can choose to use any of them in their dictionary. This process is illustrated in FIG. 8.

Once a client has created help pages, they are made accessible via the front-end website to the end-user and all Internet users. The help pages are displayed in the order they were created in hierarchical fashion, as illustrated in FIG. 7. All parent help pages are displayed first. The first-level children help pages are displayed underneath the parent help pages (FIG. 7,1), with each successive level of child help pages displayed in the same manner. All help pages containing child pages are able to expand and contract their child list (FIG. 7,4). To expand a help page, the user clicks a “+” (FIG. 7,2), which in turn calls a JavaScript function which reveals the hidden HTML layer containing child help pages and changes the “+” to a “−”. If a help page is expanded, it can be contracted by clicking the “−” (FIG. 7,3) which hides the HTML layer child help pages (FIG. 7,5) of the parent and changes the “−” back to a “+”. The page does not reload during this process.

When an end-user clicks a help page title on the front-end website, the DCTM records the click in the database for use in the statistical information and the corresponding help page opens in a new browser window. The new window displays the help page title, body, a “Back” HTML button, a “Forward” HTML button, and a list of related topic titles (hyperlinked to their corresponding help pages). The end-user may use the back and forward buttons to navigate between help pages. By clicking any of the help page titles in the related help topics list, the end-user is taken to the corresponding help page.

Discussion Forums

The discussion forum system allows the client to create, edit, and generally maintain a limited or unlimited number of discussion forums (dependent on their account type) for use by their end-users on the front-end website. There are two main interfaces available through the back-end that the client uses to create and maintain the discussion forums. The first GUI web page allows the client to create new discussion forums, edit the forum names and descriptions, delete forums, and open a micromanagement window for each forum. When a new discussion forum is created a forum name must be supplied and brief description may optionally be supplied. If the client wishes to edit any forum name and/or description, they may do so by clicking an “Edit” HTML button located to the left of each name/description pair. Once the “Edit” HTML button is clicked, a text box for each value appears underneath the corresponding value. When the client submits the page, the information is updated on the server and the page reloads. To delete a forum, the client may click the “Delete” HTML button corresponding to each forum. Once clicked, the page is submitted, the forum and all corresponding posts and information are deleted from the database and the page reloads.

To edit a forum, the client may click the “Manage Forum” HTML button corresponding to each of the discussion forums listed on the edit discussion forum GUI web page. Upon clicking the button, the corresponding discussion forum manager GUI web page opens. The window contains:

Allowed postees: When an end-user posts to a discussion forum, they are required to have a valid user account (externally created and independent of this system). When their end-user record id is recorded in the database, it is treated as a valid postee, and is allowed to post the current forum. All external users listed in the allowed postee's HTML select box list are allowed to post to the corresponding discussion forum on the front-end website. End-users may be moved from the allowed postee list to the banned postee list by selecting the end-user's username in the HTML select box and clicking the “Move” button. The end-user's usernames will not be saved in the banned postee list until the page has been submitted and the information saved in the database. Banned postee's: Once an end-user has already posted to a discussion forum, the discussion forum manager can move that end-user's username from the allowed postee's list to the banned postee's list. All end-users on the banned postee's list are banned from posting to or creating new threads in all discussion forums. End-user username's may be moved from the banned postee's list to the allowed postee's list by selecting the username in the HTML select box and clicking the “Move” HTML button. The end-user username's will not be saved in the allowed postee's list until the page has been submitted and the information saved in the database.

Forum thread list: A list of threads for the corresponding discussion forum. The forum manager may click on any thread title (which is a HTML hyperlink) to view it in its entirety. When the title is clicked, the corresponding thread opens in a new Internet browser window, with the thread contents visible. The client may post a reply to the thread from this page by click the “Reply” button and filling in the corresponding HTML text area using the WYSIYG. Upon clicking the “Post” button the new post is appended to the thread. To delete any number of threads, the HTML checkbox corresponding to each thread can be checked, and upon clicking the “Delete” HTML button, the page is submitted, and all thread information corresponding to the checked boxes is removed from the database and the page reloads.

On the front-end website, the end-user is given access to all forums created by the client on the back-end interface. Each forum consists of a series of threads. An end-user can create a new thread or add to an existing one. In both cases, the end-user uses the create thread GUI web page. The end-user must supply a thread title (in a HTML text box) and a body for the thread (in a HTML text area). Only end-users with existing end-user accounts and usernames (external to this system) may post to forums. The end-user may optionally use a HTML WYSIWYG editor to create the body of the thread. The editor allows the end-user to create rich text, and format the text of the editor. Formatting options include (but are not limited to) bolding, italicizing, underlining, justifying (left, center, right, absolute), font, size, text color, background color, superscripting, subscripting, strikethrough, copy, paste, cut, undo, redo, search, insert number list, insert bulleted list, indent, and un-indent. Once all information has been filled in, the end-user submits the page, at which point the information is saved to the database and the page reloads. None of the threads are editable once they have been created.

All discussion forum threads are made searchable through the case-insensitive word and phrase search tool on the front-end website. When a search is performed on the discussion forums, each thread title and body is searched.

All forum threads may be tracked by the end-user. Under the title of each thread in a given forum a hyperlink titled “Track Thread” is displayed. If the end-user has a valid end-user account and username they may click the “Track Thread” hyperlink and track the thread. Once a thread is tracked, any updates to that thread result in an email being sent to all end-users tracking it.

Custom Web Pages

The custom web page system allows the client to create and maintain custom web pages and website menu sections on their front-end website using a back-end graphical user interface (GUI). The number of custom web pages available to a client depends on the client account type. The GUI consists of a custom web page listing web page, which lists the web pages sorted in a client-defined order. Clients may delete any number of web pages by checking the HTML checkbox corresponding to each web page title and clicking the “Delete” HTML button. Each web page title is a HTML hyperlink that opens the web page create/edit page. The create/edit GUI web page is also accessible using the “Create Webpage” HTML link, which opens a blank GUI, allowing the client to create a new web page.

The custom web page create/edit GUI web page allows the client to specify the web page title (in a HTML text box), web page body (in a HTML text area), website menu section (create a new section or select from a list of existing website menu sections), and whether or not to make the page visible on the end-user-facing website (using an HTML select box). Furthermore, the web page body can optionally be edited/created using a HTML WYSIWYG editor. The editor allows the client to create rich text, and format the text of the editor. Formatting options include (but are not limited to) bolding, italicizing, underlining, justifying (left, center, right, absolute), font, size, text color, background color, image insertion (from the client defined image library), superscripting, subscripting, strikethrough, copy, paste, cut, undo, redo, search, insert number list, insert bulleted list, indent, and un-indent. Once a client submits the create/edit web page GUI web page, the information for the web page is saved in the database.

The custom web page display web page allows the client to view and sort their web pages and website menu sections vertically by moving them up and down. Once sorted the client may click “Save Layout” to save their current configuration.

The client may also create a new website menu section by clicking “Create Menu Section”, or they may edit an existing menu section by clicking the “Edit” link corresponding to the website menu section they wish to edit. Once either “Create Menu Section” or the aforementioned “Edit” is clicked, the edit/create menu section web page is displayed. From this page the client is presented an HTML text box where they may edit or specify a website menu section. Upon clicking “Submit” the information for this website menu section is saved in the database.

Once a client has created custom web pages, they are made accessible via the front-end web site to the end-user and all Internet users. Hyperlinks to the custom web pages are organized in the website menu in their corresponding website menu sections. The end-user navigates to the custom web pages by clicking web page title (which is a HTML hyperlink) website menu sections. Upon clicking the website page title, the end-user browser reloads with the content of the web page pulled from the database and displayed.

Query Bot

The query bot is a search engine located on the front-end. It is designed to search only the client's knowledgebase using queries written in natural English. Valid queries are of the following form:

(<QUESTION_WORD> or <SECONDARY_QUESTION_WORD>) <SENTENCE> (<CLOSING_PUNCTUATION> or <END_OF_QUEUE>)

A defined set of <QUESTION_WORD> and <SECONDARY_QUESTION_WORDS> words are provided to the query bot, along with a list of valid <CLOSING_PUNCTUATION> characters, all stored in local library files. The <SENTENCE> portion is validated using the DFS illustrated in FIG. 2 based on the dictionary words created by the client in back-end. If the DFS produces a non-empty key, it searches FAQ and help page entries in the database for matching keys, and returns any matches to the end-user. If no matches are found, the end-user is notified that no matches could be made, and the query is logged in the database where it is immediately made available to the client on the back-end in a query bot report.

The back-end query bot report available to the client lists the 50 most recent unanswered queries asked by end-users on the front end. Each query (question) is displayed as a HTML hyperlink in a HTML table along with a “Remove” HTML hyperlink. If the client clicks the query hyperlink, they are taken to the FAQ creation GUI web page. The “Question” field is populated with the query that was clicked in the query bot report page, and the rest of the form remains blank. The client is then able to create the FAQ as described above.

The Deterministic Finite State Machine (DFS)

The DFS is the underlying engine that parses end-user queries and comments. It receives a query string as input. It then processes the string in several steps, as illustrated in FIG. 2.

During the pre-processing step, the DFS breaks up the string by spaces, separating it into individual words, placing them onto a sentence queue. Step 1 (FIG. 2,1) pops items off the sentence queue, and performs case-insensitive regular expression matches on the popped item and the list of questions words it receives from its internal library. One of the following events takes place:

No match is found→The DFS pops the next value from the queue and stays at step 1 (FIG. 2,9).

A question word is matched→The word is added to the main key, and the DFS proceeds to step 2. The remainder of the sentence queue is passed to the next step (FIG. 2,4).

A secondary question word is matched AND this is the first item in the queue→The word is added to the main key, and the DFS proceeds to step 2. The remainder of the sentence queue is passed to the next step (FIG. 2,4).

Step 2 (FIG. 2,2) pops items off the sentence queue, performs case-insensitive regular expression matches on the popped item, the list of question words it receives from its internal library, a list of client defined dictionary words pulled from the database, and a list of closing punctuation characters it receives from an internal library. One of the following events takes place:

A question word is matched→The word is parsed by the key word extractor (illustrated in FIG. 9), added to the main key, and the DFS returns to step 1. The remainder of the sentence queue is passed back to step 1 (FIG. 2,5).

A dictionary word is matched→The word is parsed by key word extractor, added to the main key, the next word is popped off the queue, and the DFS remains at step 2 (FIG. 2,10).

A closing punctuation character is matched→The character is parsed by key word extractor, added to the main key, and the DFS proceeds to step 3. The remainder of the sentence queue is passed to the next step (FIG. 2,7).

The end of the queue is encountered→The DFS is finished and the question key is returned.

No match is made→The next word is popped off the queue, and the DFS remains at step 2 (FIG. 2,10).

Step 3 (FIG. 2,3) pops items off the sentence queue, and performs a case-insensitive regular expression matches on the popped item, the list of questions words it receives from its internal library and a list of closing punctuation characters it receives from an internal library. One of the following events takes place:

A question word is matched→The word is parsed by the key word extractor, added to the main key, and the DFS returns to step 1. The remainder of the sentence queue is passed back to step 1 (FIG. 2,8).

A closing punctuation character is matched→The character is parsed by key word extractor, added to the main key, the next word is popped off the queue, and the DFS remains at step 3 (FIG. 2,11).

The end of the queue is encountered→The DFS is finished and the question key is returned.

No match is made→The next word is popped off the queue, and the DFS remains at step 3 (FIG. 2,11).

The DFS will continue operating and processing as long as the sentence queue is non-empty. As soon as it becomes empty, the DFS will check to see if it has recorded at least one pass through step 3. If so, it returns the main key. If not, it returns boolean false.

The Key Word Extractor

The keyword extractor works in conjunction with the DFS. It receives a single string as input, and returns a formatted key word. There are three steps involved in parsing a key word (illustrated in FIG. 9): Break up the key word: The keyword string is broken into separate words (FIG. 9,1) tokenized by white space. Each word (FIG. 9,2) is then processed as follow:

The word is cleaned: The word is formatted by removing all non-alpha-numeric characters using a regular expression (FIG. 9,3). Determine the number of syllables present: To determine how many syllables are present in a given keyword (FIG. 10,1), the number of transitions from English consonants to English vowels is recorded. A list of both consonants (FIG. 9,6) and vowels (FIG. 9,7) is kept in an internal library. Two characters (FIG. 10,3, FIG. 10,4) (starting at the beginning of the word) are compared (FIG. 10,2). Every time a transition is observed (FIG. 9,4), the syllable count is incremented (FIG. 10,5) and the next two overlapping characters are compared (FIG. 10,6), starting the process over again. This principle is illustrated in FIG. 9 and FIG. 10.

Remove all vowels: All vowels (FIG. 9,7) are removed (FIG. 9,5) from the key word, leaving only consonants.

Build the key word: The remaining consonants and number of recorded syllables are concatenated with a colon (“:”) (FIG. 9,8) as follows:

<CONSONANTS>:<SYLLABLE_COUNT>

Create key: All parsed keywords are combined using the bell ASCII character (binary 00000110) and returned as the complete keyword (FIG. 9,9).

Client Defined Custom Calendar

The custom calendar is designed to let the client create and maintain an annual calendar with a series of custom calendar events, and also deploy other content (such as a news ticker event or an uploaded documents) automatically on a given calendar day.

The client may view their calendar with all calendar events (custom events and information deployments) displayed. Any calendar event may be edited by clicking the corresponding calendar event title. Any calendar event may be deleted by clicking the “Delete” link corresponding to the calendar event the user wishes to delete. The client may create a new calendar event by clicking the “Add Calendar Event” link. If a calendar event (custom or otherwise) has an end date (specified by the client, described below) that has already passed, the calendar event may only be viewed, and not edited. All other calendar events may be edited.

The back-end allows the client to customize the front-end display of a calendar event using a calendar event GUI web page. The client can select from three types of calendar events:

Ticker Announcement: The client may specify a start date (in an HTML input box), an end date (in an HTML input box), and select a ticker event from a list of existing ticker events (in an HTML select box). Upon clicking the “Submit” button the calendar event is saved to the database. At midnight (00:00:00) on the specified start date the ticker event is automatically deployed to the end-user facing website. At midnight (00:00:00) on the specified end date the ticker event is automatically removed from the end-user facing website.

Uploaded Document: The client may specify a start date (in an HTML input box), an end date (in an HTML input box), and select a document title from a list of existing documents (in an HTML select box). Upon clicking the “Submit” button the calendar event is saved to the database. At midnight (00:00:00) on the specified start date the document is automatically deployed to the end-user facing website on the document downloads section. At midnight (00:00:00) on the specified end date the document is automatically removed from the end-user facing website on the document downloads section.

Custom Calendar Event: The client may specify a start date (in an HTML input box), an end date (in an HTML input box), an event title (in an HTML input box), and may input a custom event body (in an HTML text area) using the WYSIWYG editor. Upon clicking the “Submit” button the calendar event is saved to the database. At midnight (00:00:00) on the specified start date the custom event is automatically displayed the end-user facing website on the calendar web page. At midnight (00:00:00) on the specified end date the custom event is automatically removed from the end-user facing website on the calendar web page.

On the front-end, an end-user may view any custom calendar event visible on the website by clicking the calendar event title. Upon clicking the title the event body is pulled from the database and displayed to the user in a new browser window.

The News and Event Ticker

The news and event ticker is used to display FAQs, help pages, advertisements, and custom messages to the end-user in a single event ticker displayed on every page of the client's front-end website.

The news and event ticker is modified by the client through a back-end news and event ticker GUI web page. The GUI allows the client to create a limited or unlimited number of events to display in the ticker based on their account type. The client enters a title for the event in a HTML text box, and selects an item type to display from a HTML pull down select menu. When an item type is selected, a JavaScript function reloads the page, instructing the page to load an appropriate subset of selections. The following items are selectable (dependent on the clients account type):

FAQ: Once a FAQ is selected, a list of all existing FAQs in the clients account are displayed in a HTML pull down select menu. Help Page: Once a help page is selected, a list of all existing help pages in the clients account are displayed in a HTML pull down select menu. Custom Message: If a custom message is selected, a text box is displayed where the client can write in custom text to display when the event is clicked. Furthermore, the custom message text can optionally be edited/created using a HTML WYSIWYG editor. The editor allows the client to create rich text, and format the text of the editor. Formatting options include (but are not limited to) bolding, italicizing, underlining, justifying (left, center, right, absolute), font, size, text color, background color, image insertion (from the client defined image library), superscripting, subscripting, strikethrough, copy, paste, cut, undo, redo, search, insert number list, insert bulleted list, indent, and un-indent.

Once the page is submitted, all information about the event is recorded in the database. If the item type selected was a custom message, the message text is written to the database, otherwise the corresponding id of the item type (FAQ, help page, or advertisement) is recorded in the database, and effectively becomes “linked” to the corresponding item type. Thus if the client should modify any corresponding item, the modifications are made effective in all corresponding data in the news and event ticker.

On the front-end, all events are displayed in a news and event ticker. Each event's title is displayed in a HTML text box and is modified using JavaScript embedded on the web page. If an end-user clicks an event's title, a new Internet browser window opens, where the corresponding information is displayed and the click is recorded by the DCTM module. If the event was linked to a non-custom message, the corresponding event's information (text, title, etc) is read from the database and displayed on the web page. If the event was a custom message, the message is read from the database and displayed on the page. The client can close the window using a “Close” button located at the bottom of the page.

Document Center

The document center system allows the client to upload files to their front- website for download and viewing by the end-user. The client accesses the file upload and maintenance GUI web page on the back-end website. The initial state of the page displays to the client a list of current files that are uploaded on their website and a list of document groups in which the files and documents are sorted and grouped. Files displayed include information about the file name, file size, file type, file description, and the visibility status of the file.

The client can click the “Upload New File” button to upload a new file to their website. The upload/edit file GUI web page allows the client to specify a file to be uploaded (using a HTML Browse button), enter a file title (in a HTML text box), write a short description of the file (in a HTML text box), a document group to place the file into (selected from a list of existing groups or created within the webpage), and choose to make the file visible on the front-end website (using a HTML select menu). When specifying a file to upload, the client can choose to search their local computer for a file using the “Browse” HTML button, or they can type in an Internet URL (in a HTML text box) that directly points the location of the file. The client must click the “Submit” HTML button to submit the page and upload the file. Once the information is submitted, all relevant data is saved. If the client chose to upload a file from their local computer using the “Browse” HTML button, the file is uploaded to their website directly, otherwise the URL they specified is saved in the database, without the physical file being uploaded. Each file name in the file list in the initial state of the GUI is presented as a HTML hyperlink, which takes the client to the upload/edit file GUI web page when clicked. Once there, the client can edit all file information including the title, description, and visibility status using the same GUI they used to create the file. If the file being edited was uploaded directly from the client's computer, the uploaded file may not be altered. If, however, a URL pointing the file was supplied, the URL may be edited. The two choices are mutually exclusive. Following each file name listing is a “View” link, which opens the file in a new Internet browser window when clicked. To remove a file, the client can check the corresponding HTML checkbox next to the file(s) they wish to delete, and click the “Delete” HTML button. The page is then submitted, and the physical file is removed from the hosting server, and all information recorded about the file is deleted from the database. Files and document groups may be sorted on file upload and maintenance web page by moving them vertically up and down. Once moved the client must click “Save Layout” to save the sorted configuration.

The end-user can access all files uploaded by the client using a front-end GUI on the front-end website. The end-user is supplied with a list of all files uploaded by the client and whose visible flag is set to “Yes”, sorted into respective document groups by the client on the back-end. All files with visible flags set to “No” are not displayed to the end-user, but are still accessible to the client on the back-end website. A client can access any file by clicking the file title (which is presented as a HTML hyperlink), at which point a new Internet browser window opens with the contents of the file. The way in which the file is displayed is determined by the browser used by the end-user. For example some browsers will display the file in the browser itself, while others might prompt the end-user to save or open the file locally, dependent on the type of file. This distinction is independent of the current application being described.

Statistics Tracking

The statistics report compiles several statistics about system usage, mainly using data collected by the DCTM module during end-user interactions with their front-end website. The client can query the data recorded in the database by the DCTM by viewing the statistics report GUI web page. There are several major metrics that are optionally recorded and tracked for each major module (FAQs, help pages, home page, discussion forums, query bot, news and event ticker) and displayed to the client. Some of the information presented on the statistics web page includes:

FAQs: The total number of clicks (views) registered, and the percentage of FAQs that have been indicated by the end-users to be helpful. Help pages: The total number of clicks (views) registered. Advertisements: The total number of clicks (views) registered.

Query bot: The total number of clicks (views) registered, the percentage and number of questions successfully answered, the percentage and number of service requests successfully answered and intercepted before submission, and the percentage of visitors who have queried the query bot.

Discussion forums: the total number of clicks (views) registered. News Ticker Clicks: the total number of clicks (views) registered. Custom Web Pages: the total number of custom web pages clicks (views) registered.

In addition to the aforementioned statistics, the client has the ability to manually compile a more detailed set of statistical reports. The statistics report GUI web page (FIG. 17,1) lists all modules accessible to the client (dependent on the client's account type) in a HTML table, with a corresponding HTML checkbox next to each module. In addition to the specific modules, a HTML text box can be populated with a day count that the client can use to specify a number of days (counting back from the present date) to search for data. The client may specify a day count (in a HTML text box), check the checkbox corresponding to the module they wish to compile statistics for, and click a submit HTML button to submit the page. Once the page has been submitted to the server (FIG. 17,2), a more detailed set of metrics (corresponding to the modules checked off by the client) are read (FIG. 17,3) from the database (FIG. 17,4) and processed (FIG. 17,5). The page then reloads with a detailed list of each module's click (view) count appended to the bottom of the page (FIG. 17,6). Each module is displayed with the total number of clicks next to it, and underneath a list of all sub-items clicked and recorded are displayed in a HTML table. Each entry in the list of clicks has a plus (“+”) to the left of it. When the plus (“+”) is clicked, the plus (“+”) becomes a minus (“−”) and a hidden HTML layer is revealed underneath the entry. The hidden layer contains information about the individuals who clicked the corresponding sub-item of the module, and when it was clicked. The sub-item information can be hidden again by clicking the minus (“−”) which then changes to a plus (“+”) again. The compilation process is illustrated in FIG. 17.

What is claimed is:

1. A customisable knowledgebase website comprising:
Frequently Asked Questions (FAQs) that can be created and edited using both a standard text area and rich text DHTML (Dynamic Hyper Text Mark-up Language) WYSIWYG (What You See Is What You Get) editor, and automatically post to the end-user accessible website; help pages that can be created and edited using both a standard text area and rich text DHTML WYSIWYG, and automatically post to the end-user accessible website; a news event ticker that can be customized and populated with links to existing FAQs, help pages; discussion forums that can be deployed, edited, and managed by the client; a query search bot that can search the client knowledgebase (comprised of FAQs and optionally help pages) if given a sentence written in English and phrased in the form of a question; a website case insensitive search engine that searches FAQs, help pages, and discussion forums for matching strings and phrases; a document center that allows the client to either upload files (from the computer they are using at that time, or point to an existing file using a URL, or “Uniform Resource Locator”) for download by their users; a client-defined and optionally editable dictionary of common words, phrases, and lingo common to their industry or line of work; a client-defined and editable list of categories and topics that broadly defines major types of information common to their industry, line of work, or subject area; an image library that allows the client to upload files (from the computer they are using at that time) for use in their FAQs, help pages, home page, custom web pages, and optionally all other areas utilizing the aforementioned DHTML WYSIWYG; a query bot report that reports to the client all questions asked through the query bot that were not matched with any data in the client's knowledgebase (FAQs and help pages); a website statistics page that reports to the client the query bot's performance thus far, the total hits to date, the average hits per day, the number of unique visitors, the number of individual hits to each major portion of the clients website, and a detailed breakdown of the hits to each section, dependent on the number of days prior to the current date that the client wishes to investigate; a user account system that allows the client to create user accounts with defined permissions to access the back-end maintenance portion of the system; a custom web page system that allows the client to create custom web pages using the aforementioned WYSIWYG editor; a customisable calendar tool that allows the client to add, remove, and edit custom events to their calendar.

2. The FAQ system according to claim 1 allows the client to create a limited or unlimited number of FAQ entries determined by the client's account type; allows the client to create new FAQs through a web page interface where the client is able to write in a question, answer, select a category to list the FAQ under, and may optionally be prompted to write in a reminder day count; allows the user to specify a day count (from the date of the FAQs creation) at which they would like to be reminded to review the content of the specific FAQ; allows the client to edit any FAQ they have created using the same interface they used to create it; allows the client to delete any number of FAQs they have created by checking the corresponding HTML checkboxes located to the left of each FAQ title, and clicking the “Delete” HTML button; allows the end-user to access all FAQs created by the client through the clients web site; allows the user to sort all FAQs according to a category previously created by the client through the back-end client facing system; allows the user to send the FAQ in an email to any valid email address, and requires the user to specify an email title, email recipient address, their (user) email address, and their (user) name, send further questions regarding the FAQ to the client automatically, using the service request contact system in claim 1, open a printer friendly, loosely formatted version of the FAQ question and answer in a new Internet browser window.

3. The help page system according to claim 1 allows the client to create a limited or unlimited number of help pages determined by the client's account type; allows the client to create new help pages through a web page interface where the client is able to write in a title and body, select a parent topic of the help page being created, select any number of related topics to assign to the help page being created, select a category to list the help page under, and may optionally be prompted to write in a reminder day count; allows the client to specify a day count (from the date of the help pages creation) at which they would like to be reminded to review the content of the specific help page; allows the client to edit any help pages they have created using the same interface they used to create it; allows the client to delete any number of help pages they have created by clicking the “Delete” HTML hyperlink located after the question title of each question; are accessible through the client's front-end web site; may contain a list of related help topics in the form of hyperlinks that link to corresponding help pages; will contain a back arrow button and forward arrow button that will allow the user to navigate to the previous and next help pages.

4. The custom web page system according to claim 1 allows the client to create a limited or unlimited number of custom web pages determined by the client's account type; will allow the client to specify a web page name by filling in an HTML text box; will allow the client to specify a website navigation menu section to under which to place the website page link; will allow the client to create a new website menu section or select from an existing website menu section; will allow the client to fill in the web page content in an HTML text area using the aforementioned WYSIWYG editor; will allow the client to select to make the custom web page visible or not visible to the user; will allow the client to sort their created custom web pages and menu, moving the pages and menu headings vertically up and down.

5. A news and event ticker system according to claim 1 will allow the client to create a limited or unlimited number of ticker items depending on the client account type; will allow the client to create a ticker event that is optionally linked to an existing help page, existing FAQ, or a custom written message; will allow the client to create a custom written text message into a HTML text area; will be displayed underneath the header/title on the client web site in a JavaScript scroller; upon being clicked will open the ticker event information (FAQ, help page, or custom written text) in a new Internet browser window.

6. A discussion forum system according to claim 1 will allow the client to create a limited or unlimited number of discussion forums dependent on their account type for use by their users; will allow the client to fill in and edit the forum title and forum description for each forum created; will allow the client to delete any forum by clicking the corresponding “Delete Forum” button and manage any forum by clicking the corresponding “Manage Forum” button; each discussion forum's forum manager HTML page will allow the client to edit a list of allowed postees to the forum, banned postees to all forums, and delete any message threads by checking the corresponding HTML checkbox to the left of each discussion forum item and clicking the “Delete” button and will allow the client to view all threads and posts in each forum by clicking the thread title (which is a hyperlink) and upon clicking the thread title, it will open a new Internet browser window, which will contain the thread corresponding to the thread title previously clicked; will allow the user to view any forum and corresponding threads created by the client; will allow the user to create a new thread and post to any existing thread in any forum of their choosing, as long as the user is not on the banned list of any forum, as specified by the client.

7. A query bot system according to claim 1 will be made available to the client, and will include the ability to uniquely name the query bot, choose one of several existing query bot images or upload an image from their local computer, and select whether or not to receive an email when receiving a new question via the query bot, and optionally setting an email address at which to receive said email; configurations will be made using a HTML configuration web page; will be made available to the users of each client and upon being asked a question by the user (phrased in English or another acceptable language), the query bot will search the clients existing FAQs and/or help pages for similar questions and titles respectively, and return to the user a list of its findings along with a hyperlink to each and the database will be searched using a unique key generated from the users question, and loosely matched to existing keys in the clients database of FAQs and help pages.

8. A word and phrase search system according to claim 1 will be made available to the user; will be made available to the users of each client and the user will supply a word or phrase, and the system will search the clients existing FAQs (question and answer) and/or help pages (title and body) and/or discussion forums (title and body) for case-insensitive matches, and return to the end-user a list of its findings along with a hyperlink to each, and a brief excerpt from each item.

9. The calendar system according to claim 1 allows the client to create a limited or unlimited number of calendar events determined by the client's account type; allows the client to create new calendar event through a web page interface; allows the client to optionally create a custom calendar event where they may write in a title, choose the start date of the event, the end date of the event, and write in a body using the aforementioned WYSIWYG; allows the client to optionally deploy an existing ticker event (according to claim 1) to the user-facing website on a chosen date by selecting a ticker event from a list of existing ticker events, choose the start date, and choose the end date; allows the client to optionally deploy an existing document to the user-facing website by selecting a document from a list of existing documents, choosing a start date, and choosing an end date; allows the client to edit any calendar event they have created using the same interface they used to create it only if the chosen end date has not passed; allows the client to strictly view an existing calendar event only if the chosen end date has passed; allows the client to delete any number of advertisements they have created by clicking the corresponding HTML hyperlink located underneath each advertisement title; allows the user to access all calendar events created by the client through the client's web site.

10. A document center system according to claim 1 will allow the client to upload files from their local computer to their website, or supply a URL that points to a file located on a third party server/website and all files uploaded or referenced will be downloadable by the end-user; will allow clients to create new documents using a HTML web page, where they will be able to specify a URL or file to upload, a title for the document, a brief description, whether or not the document is made visible to the user on the clients front-end website, and the ability to create a new menu section or select an existing document menu section under which to place the document; allows the client to sort existing documents and document menu sections by moving them vertically up and down; will be accessible by the user through the client's website where upon clicking a document title, the document contents will open in a new Internet browser window.

11. A dictionary system according to claim 1 will allow the client to manually or automatically create a limited or unlimited number of dictionary words dependent on their account type; will in part be used with the query bot described in claim 1 and claim 7, in conjunction with a deterministic finite state automaton to parse a user's question; will in part be used by FAQs and help pages described in claim 1, claim 2, and claim 3 directly or indirectly, in conjunction with a deterministic finite state automaton to parse and create a unique key for each FAQ and/or help page that will be used to identify a similar match by the query bot.

12. A category system according to claim 1 that allows the client to create a limited or unlimited number of categories and topics based on their account type; may optionally allow the client to sort their dictionary words by the categories and topics they create determined by the account type; may be used to sort FAQs and help pages created by the client described in claim 1, claim 2, and claim 3.

13. An image library according to claim 1 will allow the client to upload image files (.jpeg, .jpg, gif) from their local computer to their website, which will then be available for use in their FAQs, help pages, custom web pages, home page, and all other feature areas that may be using the aforementioned HTML WYSIWYG; will allow the client to add images using an HTML web page where client will be able to specify a file to upload from their local machine and a brief file description, will be able to delete any image by checking the corresponding HTML checkbox to the left of each existing image, and clicking the “Delete” button.

14. A statistics page according to claim 1 will allow the client to specify a number of past days for which to accumulate detailed information; will allow the client to specify which modules to compile data from (choices may optionally be from FAQs, help pages, discussion forums, custom web pages, query bot, and other optional features) where each module displays details of how many hits were received by each individual element of each selected module, and possibly who viewed the element on a given day where elements include individual FAQs, help pages, discussion forum threads, and individual custom web pages.

15. An account user system according to claim 1 that will allow the client to create additional back-end administrative users who may have access to the back-end website maintenance system; will give individuals access only to modules allowed by the client and under no circumstance will an individual account user have access to modify any client information or information about other account users; should the additional account user have access to the FAQ or help pages systems described in claim 1, claim 2 and claim 3, any items they modify or create will be recorded as being authored by said account user; will allow an additional account user to be deleted at any time by the client; may edit and delete any account user using a HTML configuration page accessible through their back-end system.
